(19) United States
(12) Patent Application Publication
(10) Pub. No.: US 2014/0282146 A1
(43) Pub. Date: Sep. 18, 2014

(54) USE OF PERSPECTIVE TO IMPROVE VISUAL INFORMATION DENSITY

(71) Applicant: SAMSUNG ELECTRONICS CO. LTD., Suwon-si (KR)

(72) Inventors: Thomas FLYNN, Cupertino, CA (US); Bartley CALDER, San Jose, CA (US); Eui Suk CHUNG, Cupertino, CA (US); Sohui WON, Sunnyvale, CA (US)

(73) Assignee: Samsung Electronics Co. Ltd., Suwon-si (KR)

(21) Appl. No.: 13/839,820

(22) Filed: Mar. 15, 2013

(51) Int. Cl. G06F 3/0481; G06F 3/0484

(52) U.S. Cl. CPC G06F 3/04817; G06F 3/04842
USPC 715/765

(57) ABSTRACT

An apparatus and method for using perspective to improve visual information density are provided. The method includes displaying images corresponding to content in a largest size including a greatest amount of visual information at a first edge of a display, and displaying images corresponding to other content in progressively smaller sizes comprising progressively less visual information at locations on the display progressively further from the first edge.

### BACKGROUND OF THE INVENTION

1. Field of the Invention

The present invention relates to an apparatus and method for use of perspective to improve visual information density. More particularly, the present invention relates to an apparatus and method for displaying and manipulating a plurality of objects or object representations by using a perspective view in which nearest objects are depicted in a largest size with the most detail, and other objects are depicted progressively smaller.

2. Description of the Related Art

Mobile terminals are developed to provide wireless communication between users. As technology has advanced, mobile terminals now provide many additional features beyond simple telephone conversation. For example, mobile terminals are now able to provide additional functions such as an alarm, a Short Messaging Service (SMS), a Multimedia Message Service (MMS), E-mail, games, remote control of short range communication, an image capturing function using a mounted digital camera, a multimedia function for providing audio and video content, a scheduling function, and many more. With the plurality of features now provided, a mobile terminal has effectively become a necessity of daily life.

One characteristic of mobile terminals is the ability to store and retrieve a large number of files. Many mobile terminals, for example, include a camera function. A user can typically take and store many photographs on a mobile terminal. Similarly, a user can record or load many music or other sound files on a mobile terminal. Similarly, a user can record or loan many video files on a mobile terminal. Other types of content may also be recorded or loaded on a mobile terminal.

In each case, a user seeking a particular content may have a large number of files to search through to find a desired file. However, if the user has not taken the time to change a file name or to add descriptive tags for each file, the user may need to look at a visual representation of each file to determine the file's contents.

Related art methods of viewing files include presenting a list or a grid of file names or icons. A file name may be useful if the user has loaded song files, for example, but may be less useful if the mobile terminal has generated a file name for a photograph, a video recording, or a sound recording. Thus, an icon may often be used to indicate file contents. An icon may be a miniature version of a photograph, for example. An icon may similarly be an attached album cover artwork for a song file, or a first frame of a video file. In each case, a user may quickly discern information of file contents from the representative icon.

In the related art a list of contents may include a file name and other information. The list may be limited to a predetermined number of lines, according to a size of the display screen and the font used.

Similarly, a grid of icons may be limited according to a standard size of each icon and a size of the screen. A gallery of photographs, for example, might include a 3×4 grid of thumbnail images. The thumbnail images will usually be easier than a file name line for a user to select if the mobile terminal uses a touchscreen interface. That is, a thumbnail image may be tapped to select and open the file.

However, if a mobile terminal has a large number of contents files stored in memory, the user may have to look through many pages of thumbnail images to locate the file he seeks. This can be time consuming and inconvenient for the user. Further, the user may have no sense of how many pages of thumbnail images or icons he has looked through.

FIG. 1 is an example of a mobile terminal display screen according to the related art.

Referring to FIG. 1, a 3×4 gallery of photographs is shown. Each photograph is shown as a thumbnail image the same size as each other. If the user does not find the photograph he seeks, he may swipe sideways to replace the current page of thumbnail images with another such page.

However, a user who takes only few photographs a day may still very quickly accumulate hundreds of photographs or more. Thus, the user may need to swipe through pages of thumbnail images dozens of times to locate a desired photograph.

Users who have significant numbers of sound recordings, video recordings, or other contents may be similarly inconvenienced when searching for a particular file.

Further, while there may be significant additional information attached to a file such as a location of recording, date/time stamp of recording, tags indicating content, etc., the user may not be able to access that information without either using a line display or selecting a particular file.

A content display according to the related art may further have no convenient way for a user to adjust a number or size of displayed content files.

Accordingly, there is a need for an apparatus and method for providing an improved user interface.

### SUMMARY OF THE INVENTION

Aspects of the present invention are to address at least the above-mentioned problems and/or disadvantages and to provide at least the advantages described below. Accordingly, an aspect of the present invention is to provide an apparatus and method for use of perspective to improve visual information density.

In accordance with an aspect of the present invention, a method for using perspective to improve visual information density is provided. The method includes displaying images corresponding to content in a largest size comprising a greatest amount of visual information at a first edge of a display, and displaying images corresponding to other content in progressively smaller sizes comprising progressively less visual information at locations on the display progressively further from the first edge.

In accordance with another aspect of the present invention, an apparatus using perspective to improve visual information density is provided. The apparatus includes a display for displaying images corresponding to content. The images are displayed in a largest size including a greatest amount of visual information at a first edge of a display, and are displayed in progressively smaller sizes comprising progressively less visual information at locations on the display progressively further from the first edge.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a mobile terminal display screen according to the related art;

FIG. 2 is an example of a perspective view of files according to an exemplary embodiment of the present invention;

FIG. 3 is an example of a perspective view of files according to an exemplary embodiment of the present invention;

FIG. 4 is an example of a perspective view of files according to an exemplary embodiment of the present invention;

FIGS. 5A-5C show a content display function according to an exemplary embodiment of the present invention;

FIGS. 6A-6C show a content display function according to an exemplary embodiment of the present invention; and

FIG. 7 is a block diagram of a portable device according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention include an apparatus and method for use of perspective to improve visual information density.

Exemplary embodiments of the present invention allow a user to display files using perspective to improve visual information density. The content files will often be sound, video, or photograph files, although the present invention is not limited thereto. For example, a user with a large number of applications may use exemplary embodiments of the present invention to peruse the loaded applications.

FIG. 2 is an example of a perspective view of files according to an exemplary embodiment of the present invention.

Referring to FIG. 2, it can be seen that the displayed files are full width at the bottom of the display, and grow proportionally smaller towards the top of the display in a manner similar to a visual perspective of nearer and farther objects. If taken to an extreme, such perspective would be analogous to a vanishing point in the fine arts. In the example of FIG. 2, the display can be thought of as being similar to a strip of images where the top of the strip is further away from the view. In this manner, images towards the top are smaller and thus more such images may be displayed in the same screen area.

Although a similar effect could be achieved by shrinking the images at the bottom of the display, the exemplary embodiment of FIG. 2 is believed to be more comforting for a user based on the common experience of having a visual horizon with objects below the horizon line and open sky above. Reversing the direction such that the bottom images are smaller would be analogous to displaying objects on a ceiling. Therefore, making the objects at the top of the screen smaller is preferred.

Although the example in FIG. 2 shows the images at the bottom of the display to be the same width as the non-perspective view, the present invention is not limited thereto. For example, the bottom images might be made large and extend off the edges of the screen to support an impression of being closer to the viewer.

Similarly, the example in FIG. 2 shows the images at the top of the display to be slightly off center, in this example to the right. This may provide the user a reinforced sense of distance perspective, although of course the present invention is not limited thereto.

Further, the example in FIG. 2 shows the images narrowing at a constant rate towards the top of the display, although the present invention is not limited thereto. For example, as shown in FIG. 3, the narrowing could include an inward curve on each side to give an impression of a strip of images that moves away and then curves up. For another example, as shown in FIG. 4, the narrowing could include an outward curve on each side to give an impression of a strip of images that moves up and then curves away from the viewer.

In each example, a maximum amount of visual information is available to the viewer in the largest image, analogous to a “closest” image. Progressively smaller images have less visual information available, but can be more densely displayed.

In an exemplary embodiment of the present invention, a user may peruse the files by a swiping or flicking motion in a first direction. The swiping or flicking motion will cause the displayed images to correspondingly flow past. The rate at which the displayed images flow past may be variably determined according to the swiping or flicking motion. For example, a user swiping quickly downwards may cause the images to flow downwards quickly; a user swiping slowly downwards may cause the images to flow downwards slowly.

The speed of the image flow may remain constant until stopped by the user or until an end of the available files is reached. Alternatively, the image flow speed may slow down and stop after the swipe, as if subject to friction. The user may preconfigure the image flow behavior.

Alternatively, a user may control the speed of the image flow according to an angle at which a device is held. For example, with a vertical image flow, the device can be configured so that if the user tilts the device to be closer to horizontal, a speed of the images flowing slows down. Alternatively, if the device is held closer to vertical, a speed of the images flowing would increase. If the device is held horizontal or tilted beyond horizontal into an opposite, e.g., top down, direction, the images would correspondingly stop and begin flow in the opposite direction.

Although this exemplary embodiment uses a vertical image flow, the present invention is not limited thereto. For example, a horizontal flow may be used, analogous to a long wall moving sideways in front of the user. The device can similarly be configured such that the speed and direction of the horizontal flow are according to the angle at which the device is held, in a manner analogous to that described above for vertical flow.

The degree of the narrowing of the images may be according to the input motion, similar to the speed of the image flow. For example, a slow swipe or slight tilt from the horizontal may cause the smallest images to shrink to half of the normal full size and flow by slowly. A quick swipe or greater tilt may cause the smallest images to shrink to a tenth of normal full size and flow by quickly. Images corresponding to all content files, or all files in a directory, may be displayed concurrently; alternatively, the display may be configured to display a predetermined number of file images. For example, the display may be configured to display twenty rows of file images. The user may configure the display to determine how many rows of file images are displayed.

The display may be configured to maintain the perspective view even after the flow of images has stopped. Alternatively, the display may be configured to return to a non-perspective fixed size display when the flow of images has stopped.

In an exemplary embodiment of the present invention, a user may drag an image that is “distant” (i.e., displayed small) to be “close” (i.e., displayed large/full size) or vise-versa. With this exemplary embodiment the user may quickly skim through the equivalent of many pages of displayed images. If the user knows which files are near a sought file, he may thus home in on the sought file quickly. For example, if photographs are ordered according to a date/time stamp when they were taken, the user may remember and easily spot other photographs taken around the same time.

The user may be able to recognize the content of a group of similar images quickly, even if the images are small and include little detail. By going immediately to the general vicinity of the sought image, the user may bring greater detail to the images by making them larger, and thus quickly home in on the sought image.

In an exemplary embodiment of the present invention, the user may immediately select and open any content file by tapping the displayed image.

FIGS. 5A-5C show a content display function according to an exemplary embodiment of the present invention.

Referring to FIG. 5A, the user has located an image 510 which he believes may correspond to the content file he seeks. In FIG. 5B the user swipes the image in a second direction. Thus, if the user swiped in a first direction (i.e., downwards) to bring the image to a “near” point in the display, he may then swipe a particular image in a second direction (i.e., right or left). The second direction is thus perpendicular to the flow direction. Swiping in the second direction will cause the image to flip in a corresponding rotation to show a “back” 530 of the image, as shown in FIG. 5C. The back 530 of the image will include additional information about the content of the file, such as a date/time stamp, a location, a duration of a sound or video recording, technical details such as a sample rate of an audio file, any tags or description added by the user, etc. The content display function may be configured to display different information according to the second direction. For example, if the second direction is from left to right, metadata such as a date and timestamp may be revealed; alternatively, if the second direction is from right to left, user-selected tags may be revealed.

The back 530 of the selected image is depicted in FIG. 5C as being displayed larger than the front. This display allows more information to be shown easily and also immediately indicates which image was selected. However, the present invention is not limited thereto. For example, the back 530 may be displayed the same size as the front of the image 510. Alternatively, the back 530 may be displayed to fill substantially the entire display area.

If the user taps the back 530 of the image, the content file will be selected and opened, the same as if the user had tapped the front of the image 510. If the user swipes in the second direction again, the image will flip back to show the front 510 again as in FIG. 5A. Thus, the user may quickly and easily check additional information on a content file without opening the file or a corresponding application such as an audio or video player.

Although the above example shows the image 510 being swiped in one sideways direction to bring up the additional information and to return to the image, the present invention is not limited thereto. For example, swiping in different directions may “flip” the image to reveal different additional information. For example, swiping to the right may reveal technical details such as a time/date stamp, a duration, and a location of recording. Swiping again may return to the image display.

Swiping in the opposite direction from the image display, for example, to the left, may reveal different information, such as user tags and descriptions of the content. Thus, if the user knows which type of information confirms the file is the one he seeks, he may flip quickly to the correct information. Thus, he would not need to skim over date/time stamp information if he knows he has tagged the content he seeks. Similarly, he might flip directly to time/date stamp information if he knows when the content was photographed or recorded.

Although the above example uses one “back” of the image in each sideways direction, the present invention is not limited thereto. Any number of “back” pages of information may be included. The user may configure the display to determine which information is included on each “back” page. Further, the “back” pages may be sequentially linked with an end page in either direction, or may form a linked ring such that the user can swipe through all “back” pages in a same direction and then return to the original image display.

In an exemplary embodiment, the user may swipe in the first (up or down) direction, to return to the front of the image and resume image flow, directly from the “back” display.

FIGS. 6A-6C show a content display function according to an exemplary embodiment of the present invention.

Referring to FIG. 6A, the content display is shown in the initial static state. All content are displayed equally in a largest size.

In FIG. 6B, the user has started the image flow with a small input. The input may, for example, be downward swipe on the screen or a tilting motion more than a threshold amount. Several more rows of content are visible in FIG. 6B than were visible in FIG. 6A. The speed at which the content flows past (in this example, downwards) is proportional to the smallest displayed content size.

In FIG. 6C, the user has entered a larger input motion. For example, the downward swipe may be longer or quicker than the motion in FIG. 6B, or the device may be tilted further from the initial position. In FIG. 6C, a much larger selection of content is visible and flows past at a higher speed. Again the speed at which the content flows past is proportional to the smallest displayed content size. For example, a smallest size at which content can be displayed would correspond to a highest speed of the content flow. The user may interrupt or change the flow speed at any time with a touch input or a change of the orientation, for example, the angle at which the device is tilted.

Although the above exemplary embodiment is described with a vertical flow direction, the present invention is not limited thereto. For example, the invention may be implemented with a horizontal image flow, wherein the smallest size content displayed is on the left or right edge of the display.

FIG. 7 is a block diagram of a portable device according to an exemplary embodiment of the present invention.

Referring now to FIG. 7, a device 700 according to an exemplary embodiment of the present invention will include a controller 710, a display 750, an input unit 760, and a memory 770.

The device 700 might optionally also include a transmitter 720 and a receiver 730 for wireless communication.

The device 700 might optionally also include an audio processor 740. If the audio processor 740 is included, then at least one of a microphone MIC and a speaker SPK may also be included.

The controller 710 controls overall operations of the device. The controller 710 may control any operations that are implicitly or explicitly performed by a device, including an operating system, applications, and control of various hardware, for example, a camera, a wireless transceiver, etc.

The display 750 provides a visual output. The input unit 760 may include one or more of buttons and a touchscreen. If the touchscreen is included, the input unit 760 and the display 750 may be combined as a single unit.

The memory 770 stores software such as an operating system or applications, and data required for or produced during use of the device 700.

The controller 710 will control all normal operations of the device 700 and of any executed applications.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for using perspective to improve visual information density, the method comprising:
displaying images corresponding to content in a largest size comprising a greatest amount of visual information at a first edge of a display; and
displaying images corresponding to other content in progressively smaller sizes comprising progressively less visual information at locations on the display progressively further from the first edge.

2. The method of claim 1, further comprising:
flowing the images towards the first edge and correspondingly increasing the size of images to reveal more visual information;
introducing new images in a smallest size at a second edge opposite the first edge; and
moving the largest images off the first edge of the display.

3. The method of claim 2, wherein the flowing is started with a swiping or flicking input motion towards the first edge.

4. The method of claim 3, wherein a speed of the flowing and the increasing of the size of images corresponds to a speed of the input motion.

5. The method of claim 4, wherein the smallest size corresponds to the speed of the flowing.

6. The method of claim 2, wherein the flowing is started with a tilt from a predetermined orientation.

7. The method of claim 6, wherein a speed of the flowing and the increasing of the size of images corresponds to an angle of the tilt.

8. The method of claim 7, wherein the smallest size corresponds to the speed of the flowing.

9. The method of claim 1, further comprising:
flowing the images away from the first edge and correspondingly decreasing the size of the images;
moving smallest images off a second edge opposite the first edge; and
introducing new images in the largest size at the first edge.

10. The method of claim 9, wherein the flowing is started with a swiping or flicking input motion away from the first edge.

11. The method of claim 10, wherein a speed of the flowing and the decreasing of the size of images corresponds to a speed of the input motion.

12. The method of claim 11, wherein the smallest size corresponds to the speed of the flowing.

13. The method of claim 9, wherein the flowing is started with a tilt from a predetermined orientation.

14. The method of claim 13, wherein a speed of the flowing and the decreasing of the size of images corresponds to an angle of the tilt.

15. The method of claim 14, wherein the smallest size corresponds to the speed of the flowing.

16. The method of claim 1, wherein a displayed image may be flipped to reveal additional information regarding the corresponding content by swiping in a direction parallel to the first edge.

17. An apparatus using perspective to improve visual information density, the apparatus comprising:
a display for displaying images corresponding to content, wherein the images are displayed in a largest size comprising a greatest amount of visual information at a first edge of a display and are displayed in progressively smaller sizes comprising progressively less visual information at locations on the display progressively further from the first edge.

18. The apparatus of claim 17, further comprising:
a controller for controlling to display flowing of the images towards the first edge and correspondingly increasing the size of images to reveal more visual information, for controlling to display new images in a smallest size at a second edge opposite the first edge, and for controlling to display movement of the largest images off the first edge of the display.

19. The apparatus of claim 18, further comprising:
a touch input for receiving a swiping or flicking input motion towards the first edge,
wherein the input motion produces a corresponding flowing of the images.

20. The apparatus of claim 19, wherein a speed of the flowing and increasing corresponds to a speed of the input motion.

21. The apparatus of claim 20, wherein the smallest size corresponds to the speed of the flowing.

22. The apparatus of claim 18, further comprising:
an orientation sensor,
wherein a sensed tilt of the apparatus produces a corresponding flowing of the images.

23. The apparatus of claim 22, wherein a speed of the flowing and increasing corresponds to an angle of the tilt.

24. The apparatus of claim 23, wherein the smallest size corresponds to the speed of the flowing.

25. The apparatus of claim 17, further comprising:
a controller for controlling to display flowing of the images away from the first edge and correspondingly decreasing the size of images, for controlling to display movement of the images of a smallest size off a second edge opposite the first edge, and for controlling to display new images in the largest size at the first edge.

26. The apparatus of claim 25, further comprising:
a touch input for receiving a swiping or flicking input motion away from the first edge,
wherein the input motion produces a corresponding flowing of the images.

27. The apparatus of claim 26, wherein a speed of the flowing and the decreasing corresponds to a speed of the input motion.

28. The apparatus of claim 27, wherein the smallest size corresponds to the speed of the flowing.

29. The apparatus of claim 25, further comprising:
an orientation sensor,
wherein a sensed tilt of the apparatus produces a corresponding flowing of the images.

30. The apparatus of claim 29, wherein a speed of the flowing and the decreasing corresponds to an angle of the tilt.

31. The apparatus of claim 30, wherein the smallest size corresponds to the speed of the flowing.

32. The apparatus of claim 17, wherein a displayed image may be flipped to reveal additional information regarding the corresponding content by swiping in a direction parallel to the first edge.
